(19) United States
(12) Patent Application Publication
(10) Pub. No.: US 2007/0052632 A1
(43) Pub. Date: Mar. 8, 2007

(54) DRIVING METHOD WHICH DRIVES DISPLAY UNITS OF DIFFERENT FREQUENCY SPECTRA WITH RESPECTIVE SWEEP SIGNALS AND APPARATUS BASED ON THE SAME

(76) Inventors: Chih-Liang Wu, Chia-Yi Hsien (TW); Ming-Tan Hsu, Miao- Li Hsien (TW)

Correspondence Address: NORTH AMERICA INTELLECTUAL PROPERTY CORPORATION, P.O. BOX 506, MERRIFIELD, VA, 22116, US

(21) Appl. No.: 11/162,294

(22) Filed: Sep. 6, 2005

(51) Int. Cl. G09G 3/30

(52) U.S. Cl. 345/76

(57) ABSTRACT

A method for driving display units having different frequency spectra includes generating a plurality of sweep signals according to luminous characteristics of a plurality of display units having different frequency spectra, and controlling luminous periods of the display units based on the corresponding sweep signals and a data voltage. Temperature variances are recorded and correction values are generated for adjusting sweep voltages.

### BACKGROUND OF THE INVENTION

1. Field of the Invention

The present invention relates to a driving method and apparatus based on the same, and more particularly, to driving method which drives display units of different frequency spectra with respective sweep signals and apparatus based on the same.

2. Description of the Prior Art

With rapid development of planar displays, more and more planar display technologies are being researched for increasing product competitiveness. In order to meet the needs of demanding applications such as e-books, smart networked household appliances, identity management cards, and display-centric handheld mobile imaging devices, the flat panel industry is now looking at new displays known as organic light emitting displays (OLED) which features self-emitting light without backlighting, high brightness, high quantum efficiency, high contrast, high reaction time, a wide viewing angle, low power consumption and a large range of operating temperature.

Depending on the driving methods used, OLEDs can be categorized into two types: active matrix organic light emitting displays (AMOLEDs) and passive matrix organic light emitting displays (PMOLEDs). The PMOLED is formed by an array of OLED pixels connected by intersecting anode and cathode conductors. To get a PMOLED to work, electrical current is passed through selected pixels by applying a voltage to the corresponding rows and columns from drivers attached to each row and column. An external controller circuit provides the necessary input power, video data signal and multiplex switches. A data signal is generally supplied to the column lines and synchronized to the scanning of the row lines. When a particular row is selected, the column and row data lines determine which pixels are lit. The PMOLED has a simple structure and is well suited for low-cost and low-information content applications such as alphanumeric displays.

In contrast to the PMOLED display, the AMOLED has an integrated electronic back plane as its substrate and lends itself to high-resolution, high-information content applications including videos and graphics. This form of display is made possible by the development of polysilicon technology, which, because of its high carrier mobility, provides thin-film-transistors (TFT) with high current carrying capability and high switching speed. In an AMOLED display, each individual pixel can be addressed independently via the associated TFTs and capacitors in the electronic back plane. Each pixel element can be selected to stay “on” during the entire frame time, or duration of the video. Therefore, AMOLEDs do not require high-brightness driving and have a longer lifetime.

When driven with a digital driving method, each pixel of the AMOLED has two states: the “bright” state with a longer luminous period, or the “dark” state with a shorter luminous period. Human eyes perceive the difference between the luminous periods during which a pixel stays “on” and feel the brightness variations. Please refer to FIG. 1 for an illustration of a prior art method for driving an AMOLED. In the prior art method, a fixed sweep signal SW and a data signal D are provided for controlling the luminous period of each pixel. S1 represents the signal of a pixel P in the “bright” state, and a luminous period T1 defined by a maximum value Dmax of the data signal D intersecting with the sweep signal SW determines the length of the “bright” state. Similarly, S2 represents the signal of the pixel P in the “dark” state, and a luminous period T2 defined by a minimum value Dmin of the data signal D intersecting with the sweep signal SW determines the length of the “dark” state.

An AMOLED usually adopts three different types of display units for emitting red, green and blue light. Since different types of display units have different luminous characteristics and efficiency, they feature different display quality within the same luminous period. The prior art method provides each type of display units with the same sweep signal SW and the data signal D and, consequently, the red, green and blue display units have the same luminous period T1 in the bright state. Therefore, in an AMOLED driven with the prior art method, the red, green and blue display units have different performances.

Please refer to FIG. 2 for a prior art AMOLED 20 disclosed in U.S. Pat. No. 6,501,230 to Rodney D. Feldman, which is included herein by reference. The AMOLED 20 includes a display panel 102, a video interface circuit 24, an aging correction circuit 112, a plurality of summing amplifier 116, and an age circuit 118. The age circuit 118 fetches video information of the display panel 102 and sends the data to the aging correction circuit 112. The aging correction circuit 112 includes a controller 120, a plurality of memory units 122, a plurality of latches 124, and a plurality of digital-to-analog converter (DAC) 126. The aging correction circuit 112 generates correction signals 114 corresponding to the display panel 102 based on data sent from the aging circuit 118. Based on the correction signals 114 and images signals 108 generated by the video interface circuit 24, the summing amplifiers 116 generate driving signals 104 for driving the display panel 102. The AMOLED 20 adopts an external circuit for adjusting the display quality of the display panel 102. Therefore, extra efforts are required for designing the video interface circuit 24, the aging correction circuit 112, the summing amplifier 116, and the age circuit 118, etc.

Please refer to FIG. 3 for a prior art AMOLED 30 disclosed in US patent application publication No. 2004/0150592 to Seiichi Mizukoshi, Nobuyuki Mori, Kouichi Ononmura and Makoto Kohno, which is included herein by reference. The AMOLED 30 includes a display panel 32, look-up-tables 34R, 34G and 34B, address generators 35R, 35G and 35B, digital-to-analog converters 36R, 36G and 36B, a correction offset generating circuit 37, a central processing unit (CPU) 38, and a current detector 39. The current detector 39 measures output currents of the display panel 32. Based on the measured current, the CPU 38 and the correction offset generating circuit 37 calculate and generated correction offset coefficients for adjusting the display quality of the display panel 32.

### SUMMARY OF THE INVENTION

It is therefore a prime objective of the present invention to provide a driving method and apparatus based on the same in order to solve the above-mentioned problems.

The claimed invention discloses a display apparatus comprising a display panel, a memory and a driving circuit. The display panel includes a plurality of display units with different frequency spectra. The memory stores a plurality of distinct sweep signals generated according to luminous characteristics of the display units. The driving circuit is electrically connected to the memory and the display panel for driving the display units according to the sweep signals stored in the memory.

The claimed invention also discloses a method for driving display units having different frequency spectra comprising generating a plurality of sweep signals according to luminous characteristics of a plurality of display units having different frequency spectra, and controlling luminous periods of the display units based on the corresponding sweep signals and a data voltage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a prior art method for driving an AMOLED.

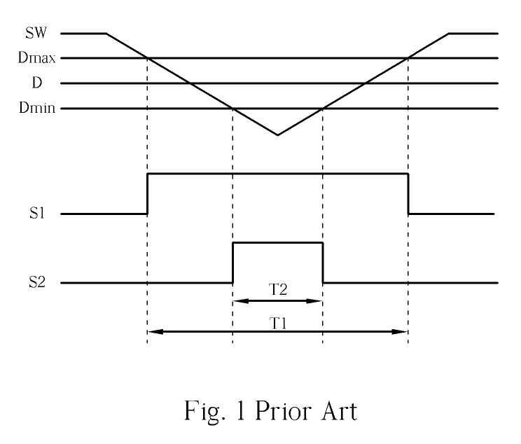

FIG. 2 is a diagram of a prior art AMOLED.

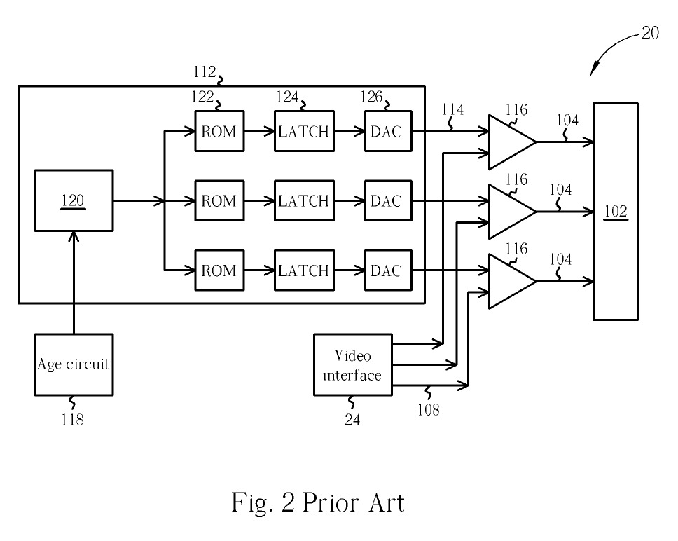

FIG. 3 is a diagram of another prior art AMOLED.

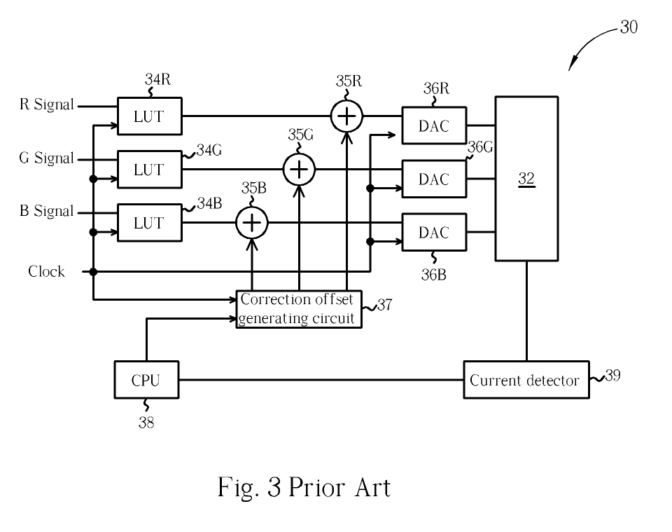

FIG. 4 is a diagram of an AMOLED according to the present invention.

FIG. 5 illustrates a method for driving an AMOLED according to the present invention.

FIG. 6 is a flowchart illustrating a method for driving an AMOLED according to the present invention.

### DETAILED DESCRIPTION

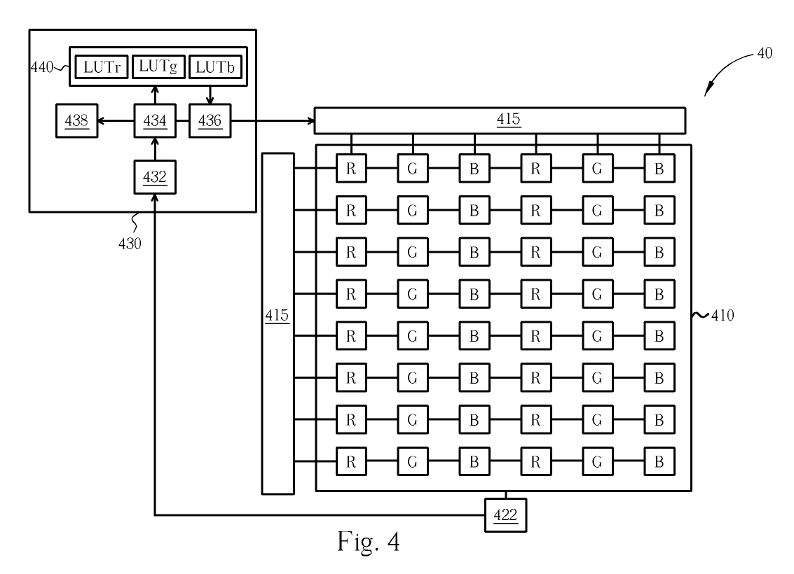

Please refer to FIG. 4 for a diagram of an active matrix organic light emitting display (AMOLED) 40 according to the present invention. The AMOLED 40 includes a display panel 410, a driving circuit 415, a sensor 422 and a signal processing circuit 430. The display panel 410 includes a plurality of display units with different frequency spectra. In the embodiment shown in FIG. 4, the display panel 410 includes 16 red light emitting diodes R, 16 green light emitting diodes G and 16 blue light emitting diodes B formed in a matrix. The sensor 422 is electrically connected to the display panel 410 for sensing temperature variances in an operating environment of the AMOLED 40.

The signal processing circuit 430 is electrically connected to the driving circuit 415 and the sensor 422 and includes an analog-to-digital converter (ADC) 432, a digital signal processor (DSP) 4 34, a digital-to-analog converter (DAC) 436 and memory units 438 and 440. The ADC 432, electrically connected to the sensor 422, receives analog signals from the sensor 422, converts received analog signals into digital signals and outputs the converted digital signals. The DSP 434, electrically connected to the ADC 432, receives digital signals from the ADC 432, processes received digital signals and outputs the processed digital signals. The memory unit 438 is electrically connected to the DSP 434 and stores data required by the DSP 434 during data processing. The memory unit 440 is electrically connected to the DSP 434 and includes three look-up-tables (LUT): LUTr, LUTg and LUTb. Sweep signals SWr corresponding to the display units R, sweep signals SWg corresponding to the display units G and sweep signals SWb corresponding to the display units B are stored in the LUTr, LUTg and LUTb, respectively. The DAC 436, electrically connected to the DSP 434 and the memory unit 440, receives digital signals from the DSP 434 and the memory unit 440, converts received digital signals into analog signals, and outputs the converted analog signals.

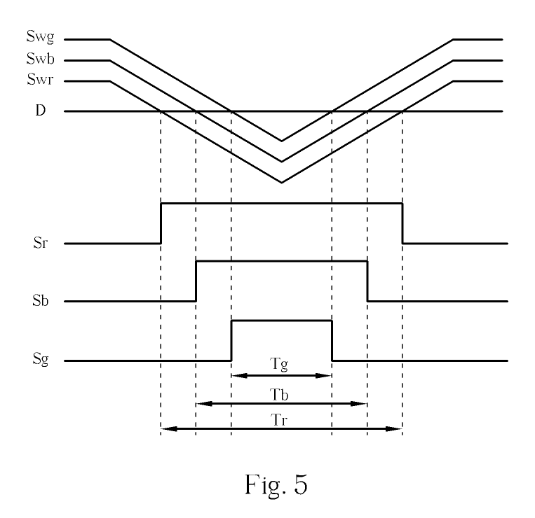

Please refer to FIG. 5 for an illustration of a method for driving the AMOLED 40 according to the present invention. Based on the luminous characteristics of the display units R, G and B, the present invention method provides corresponding sweep signals SWr, SWg and SWb and a data signal D. In the embodiment shown in FIG. 5, the sweep signals SWr, SWg and SWb are generated as triangular waveforms with distinct voltage levels. Sr stands for the signal of a pixel Pr representing the display unit R in the “bright” state, and a luminous period Tr defined by the data signal D intersecting with the sweep signal SWr determines how long the pixel Pr stays in the bright state. Sg stands for the signal of a pixel Pg representing the display unit G in the “bright” state, and a luminous period Tg defined by the data signal D intersecting with the sweep signal SWg determines how long the pixel Pg stays in the “bright” state. Sb stands for the signal of a pixel Pb representing the display unit B in the “bright” state, and a luminous period Tb defined by the data signal D intersecting with the sweep signal SWb determines how long the pixel Pb stays in the “bright” state.

The sweep signals SWr, SWg and SWb of different voltage levels results in different luminous periods Tr, Tg and Tb for the display units R, G and B. The voltage levels of the sweep signals SWr, SWg and SWb are determined based on the luminous characteristics so that the same display quality can be achieved by selecting the display unit R to stay “on” with a duration of the luminous period Tr, selecting the display unit G to stay “on” with a duration of the luminous period Tg and selecting the display unit B to stay “on” with a duration of the luminous period Tb. For example, if in the AMOLED 40 the display units R provide the lowest luminous intensity, followed by the display units B, and the display units G provide the highest luminous intensity, the present invention shown in FIG. 5 provides sweep voltages with voltage levels SWr<SWb<SWg, resulting in luminous periods Tr>Tb>Tg. The differences between the luminous periods Tr, Tg and Tb can compensate different luminous intensities of the display units R, G and B. Therefore, the present invention can improve display quality of the AMOLED 20 by adjusting sweep signals corresponding to different types of display units.

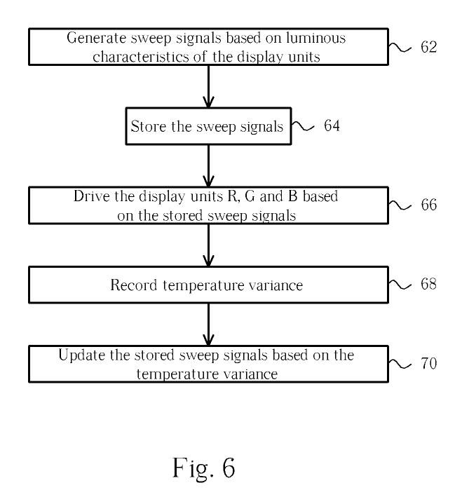

Please refer to FIG. 6 for a flowchart illustrating a method for driving the AMOLED 40 according to the present invention. FIG. 6 includes the following steps:

Step 62: Generate sweep signals SWr, SWg and SWb based on luminous characteristics of the display units R, G and B, respectively;

Step 64: Store the sweep signals SWr, SWg and SWb in the signal processing circuit 430;

Step 66: Drive the display units R, G and B based on the sweep signals SWr, SWg and SWb and a data voltage D;

Step 68: Record temperature variance with the sensor 422 and send temperature data to the signal processing circuit 430;

Step 70: Update the sweep signals SWr, SWg and SWb based on the temperature data; perform step 44.

Since ambient temperature also influences the luminous characteristics of the display units, the sensor 422 of the AMOLED 40 can record temperature variance for adjusting sweep voltages. In step 62, sweep signals SWr, SWg and SWb based on luminous characteristics of the display units R, G and B are generated. In step 64, the sweep signals SWr, SWg and SWb are stored in the look-up-tables LUTr, LUTg and LUTb, respectively. Then in step 66, the display units R, G and B are driven based on the sweep signals SWr, SWg and SWb and a data voltage D. In step 68, the sensor 422 records a temperature difference and sends data to the ADC 432 for converting analog data into digital data. After receiving digital data representing the temperature difference from the ADC 432, the DSP 434 generates correction values due to the temperature difference. Then in step 70, the original sweep signals SWr, SWg and SWb stored in the LUTr, LUTg and LUTb are updated according to the correction values. Finally the DAC 438 converts the updated sweep signals SWr, SWg and SWb into analog signals and outputs the converted signals to the driving circuit 415. Therefore, the driving circuit 415 drives the corresponding display units based on the updated sweep signals and the temperature variance can be compensated.

In conclusion, the present invention provides an AMOLED which drives display units of different frequency spectra with respective sweep signals. By generating sweep signals according to the luminous characteristics of each type of display units, different luminance values of the display units can be compensated. The present invention also modifies changes in luminous characteristics of the display units due to temperature variations by adjusting the sweep signals according to the temperature data and thus offers better display quality.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display apparatus which drives display units of different frequency spectra with respective sweep signals, comprising:
a display panel having a plurality of display units with different frequency spectra;
a first memory for storing a plurality of distinct sweep signals generated according to luminous characteristics of the display units; and
a driving circuit electrically connected to the first memory and the display panel for driving the display units according to the sweep signals stored in the first memory.

2. The display apparatus of claim 1 further comprising a sensor electrically connected to the display panel for sensing temperature variances in an operating environment of the display apparatus.

3. The display apparatus of claim 2 further comprising:
an analog-to-digital converter electrically connected to the sensor for receiving analog signals from the sensor, converting received analog signals into digital signals, and outputting the converted digital signals;
a digital signal processor electrically connected to the analog-to-digital converter for receiving digital signals from the analog-to-digital converter, processing received digital signals, and outputting the processed digital signals;
a second memory electrically connected to the digital signal processor for storing data required by the digital signal processor during data processing; and
a digital-to-analog converter electrically connected to the digital signal processor and the memory for receiving digital signals from the digital signal processor and the first memory, converting received digital signals into analog signals, and outputting the converted analog signals.

4. The display apparatus of claim 3 wherein the second memory is an erasable programmable read-only memory (EPROM).

5. The display apparatus of claim 1 being an organic light emitting diode display (OLED).

6. The display apparatus of claim 1 being an active-matrix organic light emitting diode display (AMOLED).

7. The display apparatus of claim 1 wherein the display units include a red light emitting diode, a green light emitting diode and a blue light emitting diode.

8. A method for driving display units having different frequency spectra, comprising:
(a) generating a plurality of sweep signals according to luminous characteristics of a plurality of display units having different frequency spectra; and
(b) controlling luminous periods of the display units based on the corresponding sweep signals and a data voltage.

9. The method of claim 8 wherein step (a) generates the sweep signals according to luminous characteristics of the display units having different frequency spectra and the operating temperate of the display units.

10. The method of claim 8 further comprising updating the sweep signals according to an operating temperate of the display units.

11. The method of claim 10 wherein updating the sweep signals is by generating correction values according to the operating temperate of the display units and luminous characteristics of the display units.

12. The method of claim 8 wherein step (a) generates the sweep signals having distinct voltage levels.

13. The method of claim 8 wherein step (a) generates the sweep signals having identical waveforms and distinct voltage levels.

14. The method of claim 8 wherein step (a) generates the sweep signals having triangle waveforms of distinct voltage levels.

15. The method of claim 8 wherein step (a) generates red sweep signals, green sweep signals and blue sweep signals according to luminous characteristics of a red light emitting diode, a green light emitting diode and a blue light emitting diode, respectively.

16. The method of claim 16 wherein the green sweep signals have higher voltage level than the blue sweep signals, and the blue sweep signals have higher voltage level than the red sweep signals.
